(19) United States
(12) Patent Application Publication
(10) Pub. No.: US 2023/0374424 A1
(43) Pub. Date: Nov. 23, 2023

(54) LAUNDRY DETERGENT COMPOSITION

(71) Applicant: Church & Dwight Co., Inc., Princeton, NJ (US)

(72) Inventors: Aidi Kong, Princeton, NJ (US); Steven T. Adamy, Lawrenceville, NJ (US); Archana Gupta, Belle Mead, NJ (US); Leilani Pechera, Kendall Park, NJ (US)

(73) Assignee: Church & Dwight Co., Inc., Princeton, NJ (US)

(21) Appl. No.: 18/031,323

(22) PCT Filed: Oct. 12, 2021
(86) PCT No.: PCT/US2021/054466

§ 371 Date: Apr. 11, 2023

Related U.S. Application Data
(60) Provisional application No. 63/091,096, filed on Oct. 13, 2020.

(51) Int. Cl. C11D 17/04; C11D 3/04; C11D 3/10

(52) U.S. Cl. CPC C11D 17/043; C11D 3/046; C11D 3/10

(57) ABSTRACT

An article is provided herein which includes an aqueous liquid detergent and a package for the aqueous liquid detergent which is in direct contact with the aqueous liquid detergent, wherein the package is formed from a water-soluble, film-forming material. The aqueous liquid detergent includes at least about 25% by weight of water based on the total weight of the aqueous liquid detergent, and at least about 25% by weight of a water-binding agent based on the total weight of the aqueous liquid detergent. The pH of the aqueous liquid detergent is in the range of about 7 to about 10, and the water activity of the aqueous liquid detergent is in the range of about 0.34 to about 0.64.

### FIELD OF THE INVENTION

The present invention relates to compositions for use in laundry machines, and more particularly to a high-water content liquid detergent composition configured for use in a unit dosage form.

### BACKGROUND

This invention relates to high water content liquid laundry detergents in unit dosage form in a package comprising a water-soluble, film-forming material.

The use of water-soluble film packages to deliver unit dosage amounts of laundry products is well known. Granular detergents and granular bleaches have been sold in this form in the United States for many years. A compact granular detergent composition in a water-soluble film pouch has been described in Japanese Patent Application No. 61-151032, filed Jun. 27, 1986, which is incorporated herein by reference. A paste detergent composition packaged in a water-soluble film is disclosed in Japanese Patent Application No. 61-151029, also filed Jun. 27, 1986. Further disclosures relating to detergent compositions which are either pastes, gels, slurries, or mulls packaged in water-soluble films can be found in U.S. Pat. No. 8,669,220 to Huber et al.; U.S. Pat. App. Pub. Nos. 2002/0033004 to Edwards et al., 2007/0157572 to Oehms et al., and 2012/0097193 to Rossetto et al.; Canadian Patent No. 1,112,534 issued Nov. 17, 1981; and European Patent Application Nos. 158464 published Oct. 16, 1985 and 234867, published Sep. 2, 1987; each of which is incorporated herein by reference. A liquid laundry detergent containing detergents in a water/propylene glycol solution is disclosed in U.S. Pat. No. 4,973,416, which is herein incorporated by reference. See, also, U.S. Pat. No. 7,915,213 to Adamy et al. and U.S. Pat. App. Pub. No. 2006/0281658 to Kellar et al., which disclose high builder compositions in pods and are both herein incorporated by reference.

It is generally believed that high water content liquid laundry detergents are incompatible with water-soluble films because of their water content. Thus, the attendant advantages of high water content liquid laundry detergents over other forms of laundry detergents such as granules, pastes, gels, and mulls have not been readily available in water-soluble unit dosage form. The advantages of liquid laundry detergents over granules, pastes, gels, and mulls include their aesthetic appearance and the faster delivery and dispersibility of the detergent ingredients to the laundry wash liquor, especially in a cool or cold water washing process.

The use of a water-soluble alkaline carbonate builder in the detergent composition can help prevent the aqueous detergent composition from dissolving the water-soluble package material. Laundry detergent compositions comprising a water-soluble alkaline carbonate are well-known in the art. For example, it is conventional to use such a carbonate as a builder in detergent compositions which supplement and enhance the cleaning effect of an active surfactant present in the composition. Such builders improve the cleaning power of the detergent composition, for instance, by the sequestration or precipitation of hardness causing metal ions such as calcium, peptization of soil agglomerates, reduction of the critical micelle concentration, and neutralization of acid soil, as well as by enhancing various properties of the active detergent, such as its stabilization of solid soil suspensions, solubilization of water-insoluble materials, emulsification of soil particles, and foaming and sudsing characteristics. Other mechanisms by which builders improve the cleaning power of detergent compositions are less well understood. Builders are important not only for their effect in improving the cleaning ability of active surfactants in detergent compositions, but also because they allow for a reduction in the amount of the surfactant used in the composition, the surfactant being generally much costlier than the builder.

Sodium carbonate (Na₂CO₃) and/or potassium carbonate (K₂CO₃) are the most common carbonates included in laundry detergents to impart increased alkalinity to wash loads, thereby improving detergency against many types of soils. In particular, soils having acidic components e.g. sebum and other fatty acid soils, respond especially well to increased alkalinity.

While laundry detergents containing a relatively large amount of carbonate builder are generally quite satisfactory in their cleaning ability, the use of such carbonate builders often results in the problem of calcium carbonate precipitation, which may give rise to fabric encrustation due to the deposition of the calcium carbonate on the fiber surfaces of fabrics which in turn causes fabric to have a stiff hand and gives colored fabrics a faded appearance. Thus, any change in available carbonate built laundry detergent compositions which reduces their tendency to cause fabric encrustation is highly desirable.

In many applications, it is desirable to include Na₂CO₃ and K₂CO₃ in detergent formulations at levels greater than 20%. This is readily achieved in the case of a powdered detergent. However, incorporating such large amounts into an aqueous liquid is much more difficult. In liquid laundry detergent compositions, the incorporation of a large amount of detergent builder poses a significant formulation challenge since the presence of a major quantity of detergent builder inevitably causes the detergent composition to phase separate. Liquid detergent formulations that contain a detergent builder ingredient require careful control of the surfactant to builder ratio so as to prevent salting-out of the surfactant phase. Liquid laundry detergent compositions are also susceptible to instability under extended freeze/thaw and high/low temperature conditions.

Additionally, sodium carbonate forms an extensive array of low water soluble hydrates at low temperatures and high, i.e., >15 wt. % levels of the sodium carbonate builder. For example, a system with 20% carbonate builder will form a decahydrate phase below 23° C. At 30% sodium carbonate, the decahydrate will form below 31° C. Therefore, even at room temperature, systems containing greater than 20% carbonate builder are inherently unstable and readily form decahydrate phases. Once the decahydrate forms, redissolution can take an inordinate amount of time.

In addition, it has recently been discovered that aqueous detergent compositions comprising a carbonate builder can turn yellow over time and aged films can be difficult to dissolve in cold water. As is known in the art, water-soluble films used in unit dose laundry detergents can be partially hydrolyzed polyvinyl alcohol acetate films (PVOAc) or its derivatives. Without intending to be limited by theory, it has been hypothesized that the high level of carbonate builder present in the detergent composition may result in an overly alkaline detergent resulting in the water-soluble films being further hydrolyzed into forms which are more difficult to dissolve in water.

Accordingly, there is still a desire and a need to provide a stable liquid high-water content laundry detergent that is still suitable for use in forming dose packs or pods with a water-soluble, film-forming material, which is in direct contact with the liquid laundry detergent.

### SUMMARY OF THE INVENTION

In one aspect of the present invention, an aqueous liquid detergent is provided. An article is also provided herein, the article comprising an aqueous liquid detergent and a package for the aqueous liquid detergent which is in direct contact with the aqueous liquid detergent, wherein the package is formed from a water-soluble, film-forming material. In various embodiments, the water-soluble, film-forming material is polyvinyl alcohol.

In various embodiments of the present disclosure, an article is provided comprising: an aqueous liquid detergent and a package for the aqueous liquid detergent which is in direct contact with the aqueous liquid detergent, wherein the package is formed from a water-soluble, film-forming material. In certain embodiments, an article according to the present disclosure can comprise an aqueous liquid detergent that includes at least about 25% by weight of water based on the total weight of the aqueous liquid detergent and at least about 25% by weight of a water-binding agent based on the total weight of the aqueous liquid detergent, the aqueous liquid detergent having a pH in the range of about 7 to about 10 and having a water activity in the range of about 0.30 to about 0.64, and the article can also comprise a package for the aqueous liquid detergent which is in direct contact with the aqueous liquid detergent, wherein the package is formed from a water-soluble, film-forming material. In further embodiments, the article can be further defined in relation to any one or more of the following statements, which can be combined in any number and order.

The water-binding agent can comprise at least one inorganic salt, preferably potassium acetate.

The water-binding agent can be present in an amount in the range of about 30 to about 40 weight percent based on the total weight of the aqueous liquid detergent.

The article further can comprise at least one surfactant.

The water-soluble film-forming material can be polyvinyl alcohol.

The article further can comprise a chloride salt.

The chloride salt can be potassium chloride.

The aqueous liquid detergent can have a pH in the range of about 7.5 to about 9.

The water activity of the aqueous liquid detergent can be in the range of about 0.4 to about 0.60.

The water can be present in an amount of about to about 45 weight percent, based on the total weight of the aqueous liquid detergent.

The water-binding agent can be substantially free of organic compounds.

The water-binding agent can have a negative entropy of hydration associated with the cation and an entropy of hydration for the anion on the order of less than about −500 J/K.

The concentration of the water-binding agent in the aqueous liquid detergent composition can be in the range of about 5 to about 40% (w/w/).

In some embodiments, the present disclosure can provide an aqueous liquid detergent comprising: at least about 25% by weight of water based on the total weight of the aqueous liquid detergent; and at least about 25% by weight of a water-binding agent based on the total weight of the aqueous liquid detergent; wherein the pH of the aqueous liquid detergent is in the range of about 7 to about 10; and wherein the water activity of the aqueous liquid detergent is in the range of about 0.34 to about 0.64. In further embodiments, the aqueous liquid detergent can be further defined in relation to any one or more of the following statements, which can be combined in any number and order.

The water-binding agent can comprise at least one inorganic salt, preferably potassium acetate.

The water-binding agent can be present in an amount in the range of about 30 to about 40 weight percent based on the total weight of the aqueous liquid detergent.

The aqueous liquid detergent further can comprise at least one surfactant.

The aqueous liquid detergent further can comprise a chloride salt.

The chloride salt can be potassium chloride.

The aqueous liquid detergent can have a pH in the range of about 7.5 to about 9.

The water activity of the aqueous liquid detergent can be in the range of about 0.40 to about 0.60.

The water can be present in an amount of about 20 to about 45 weight percent, based on the total weight of the aqueous liquid detergent.

The water-binding agent can be substantially free of organic compounds.

The water-binding agent can have a negative entropy of hydration associated with the cation and an entropy of hydration for the anion on the order of less than about −500 J/K.

The concentration of the water-binding agent in the aqueous liquid detergent composition can be in the range of about 5 to about 40% (w/w/).

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE DRAWINGS

FIG. 1 is a plot of the correlation of entropies of hydration between cation and anion for different salts and salt concentrations.

### DETAILED DESCRIPTION OF THE INVENTION

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one aspect of the present invention, an article is provided, the article for use in the laundry process comprising an aqueous liquid detergent and a package for the aqueous liquid detergent. More particularly, the article is an aqueous, organic solvent free, liquid laundry detergent contained in a package, preferably a pouch or packet, containing a unit dose of the liquid laundry detergent, the package comprising a water soluble film-forming material that dissolves when placed in the laundry wash water so as to release the liquid laundry detergent. As used herein, terms such as “package”, “pod”, “pouch”, and the like can be used interchangeably to describe the water-soluble film forming the article enclosing liquid laundry detergents described herein. According to the invention, the water-soluble film-forming material is in substantially direct contact with the liquid laundry detergent, with the film-forming material maintaining its structural integrity prior to external contact with an aqueous medium, such as a laundry wash liquor. The liquid detergent is capable of remaining homogeneous over a relatively wide temperature range, such as might be encountered in storage, and the pouch is capable of dissolution in water even after extended storage.

The water-soluble package of this invention can preferably be made from partially hydrolyzed polyvinyl alcohol acetate (PVOAc) or its derivatives, but can also be cast from other water-soluble materials such as polyethylene oxide, methyl cellulose and mixtures thereof. Suitable water-soluble films are well known in the art and are commercially available from numerous sources.

The liquid laundry detergent package itself can be of any configuration or shape, but conveniently may have a rectangular or square shape when viewed normally to the plane of its two longest dimensions. A rectangular or square packet is more easily manufactured and sealed than other configurations when using conventional packaging equipment. In certain embodiments, the aqueous laundry detergent compositions described herein can be combined with other detergent compositions to make multi-chambered unit dose products. As such, various shapes and sizes of unit does pods are contemplated herein.

The liquid laundry detergent for use in this invention is formulated in a manner which makes it compatible with the water-soluble film for purposes of packing, shipping, storage, and use. Without being limited by theory, compatibility of the liquid laundry detergent with the water-soluble film can be achieved by the use of an appropriate salt in the liquid laundry detergent composition. The liquid laundry detergent is a concentrated, heavy-duty liquid detergent which can contain at least about 25 weight percent of water, at least about 30 weight percent of water, at least about 40 weight percent of water, at least about 50 weight percent water, or at least about 60 weight percent of water, based on the weight of the overall detergent composition. In some embodiments, water can be present in an amount of about 25 weight percent to about 50 weight percent, about 25 weight percent to about 45 weight percent, about 30 weight percent to about 40 weight percent, or about 30 weight percent to about 35 weight percent, based on the total weight of the detergent composition.

As described herein, embodiments of the invention relate to an aqueous liquid detergent, which can be encapsulated in a water-soluble package. In particular, various embodiments of the present invention relate to an aqueous liquid detergent comprising a suitable water-binding agent (e.g., compounds, and particularly salts, such as potassium acetate and the like, that exhibit properties as otherwise described herein). The formulations are essentially homogenous (show substantially no phase separation, such as less than 2% or less than 1% by volume separation) for an extended time period and temperature range. They are not clear transparent liquids, but are rather turbid and similar in form to pastes or gels. While homogeneity of the formulations provides a desirable product appearance, phase separation can also be a product performance issue, since both phases in a phase-separated system may not disperse and dissolve rapidly during the wash cycle, although the formulation may have dispersed and dissolved rapidly before phase separation occurred.

The water-binding agent in the detergent composition can comprise, for example, a salt. The presence of the water-binding agent in the formulation renders the aqueous liquid detergent substantially non-solubilizing relative to the water-soluble pouch (made from, for example, polyvinyl alcohol and/or polyvinyl acetate). Substantially non-solubilizing can particularly mean, for example, that the water-soluble pouch exhibits less than 5%, less than 2%, or less than 1% by mass solubilization and/or that insufficient solubilization occurs to be the cause of a leak or rupture of the pouch over a storage time of at least three months. As such, the presence of the water-binding agent results in compatibility between the pouch and the formulation by preventing the aqueous detergent from dissolving the water-soluble package within which the aqueous detergent is stored. The water-binding agent also allows for the detergent composition to comprise a higher water content than the water content of many conventional detergent packages. The high water content of the formulations of the present invention, in addition to allowing rapid dispersion and dissolution in the wash cycle, can result in a significant cost reduction, thereby making a pouch-type detergent available to the consumer at a significantly lower price.

In one or more embodiments, the water-binding agent can comprise a salt. The salt particularly may be defined in relation to the specific combination of cationic and anionic moieties forming the salt. In some embodiments, the cationic component of the salt may be an alkali metal or an alkaline earth metal or may be an ammonium moiety. Sodium and potassium can be particularly useful as the cationic component of the salt. In some embodiments, the anionic component of the salt may be chlorine, carbonate, phosphate, nitrate, sulfate, sulfite, citrate, or acetate moieties. Citrates and acetates can be particularly useful as the anionic component of the salt.

A salt suitable for use as a water-binding agent as described herein can particularly be defined in relation to the entropy of hydration (ΔS_{hyd}) of the salt. Entropy of hydration is defined as the change in entropy associated with transferring an ion in the gas phase to the aqueous phase. The change in entropy is indicative of the degree to which ions structure molecules of water around them when the ions are in solution. Ions with highly negative values of ΔS_{hyd} are referred to as “structure making” ions, while those with less negative values of ΔS_{hyd} are referred to as “structure breaking” ions. The ΔS_{hyd} value can be calculated utilizing molar values from literature known in the art as shown in the appended Examples. Testing according to the present disclosure has identified that the ΔS_{hyd} value can be used as an indicator of the suitability of a particular salt for use as a water-binding agent in detergent composition for storage in a water-soluble package to reduce or eliminate undesired dissolution of the package. Preferably, a salt for use according to the present disclosure thus will have an entropy of hydration for the cation (i.e., ΔS_{hyd}(+)) of less than 0 J/K, such as in the range of about −1000 J/K to 0 J/K. A suitable entropy of hydration for the anion (i.e., ΔS_{hyd}(−)) then can be any value equal to or less than the value calculated from the known entropy of hydration of the cation using equation [1] below:

ΔS_{hyd}(−)=−6.890×10⁻⁴[ΔS_{hyd}(+)]²+0.121[ΔS_{hyd}(+)]−548.39 equation [1].

In some embodiments, the entropy of hydration for the anion can be less than 0 J/K, such as in the range of about −2000 J/K to about 0 J/K. While the most preferable salts are defined by the limits of entropies of hydration as described by the equation above, it is generally desired to choose salts having a negative entropy of hydration associated with the cation and an entropy of hydration for the anion on the order of less than −500 J/K.

In various embodiments, the water-binding agent can comprise a salt selected from the group consisting of sodium chloride (NaCl), potassium chloride (KCl), potassium carbonate (KCO₃), sodium carbonate (Na₂CO₃), magnesium chloride (MgCl₂), calcium chloride (CaCl₂), strontium chloride (SrCl₂), sodium acetate (NaAc), potassium acetate (KAc), magnesium acetate (MgAc), calcium acetate (CaAc), strontium acetate (SrAc), sodium phosphate (NaH₂PO₄), disodium phosphate (Na₂HPO₄), trisodium phosphate (Na₃PO₄), monopotassium phosphate (KH₂PO₄), dipotassium phosphate (K₂HPO₄), tripotassium phosphate (K₃PO₄), sodium sulfate (Na₂SO₄), sodium sulfite (Na₂SO₃), sodium bisulfite (NaHSO₃), sodium nitrate (NaNO₃), ammonium chloride (NH₄Cl), lithium chloride (LiCl), sodium citrate, or combinations thereof. In various embodiments, the water-binding agent is potassium acetate. As described in Example 1 below, in various embodiments, the water-binding agent does not include a chloride salt. It was surprisingly discovered based on entropy of hydration calculations that for use as a water-binding agent, chloride salts are not preferred, and instead sulfates, carbonates and acetates are preferred.

The aqueous liquid detergents of the present invention can comprise a water-binding agent in an amount of about 15% to about 50% by weight, about 20% to about 40% by weight, or about 25% to about 35% by weight, based on the total weight of the aqueous liquid detergent. In certain embodiments, the detergent composition can comprise a water-binding agent in an amount of at least about 15% by weight, at least about 25% by weight, or at least about 30% by weight, based on the total weight of the aqueous liquid detergent.

The presence of the water-binding agent in the detergent composition can render the composition susceptible to phase changes and separations before the composition reaches its final paste/slurry (homogeneous) form. For example, a formula comprising only potassium carbonate (i.e., no chloride salt) goes through a gel phase and then complete separation before reaching a final paste/slurry form. By adding a chloride salt to the detergent composition, the gel formation is eliminated and the phase separation is reduced, thereby easing the mixing/preparation process of detergent compositions according to the present disclosure. As such, embodiments of the aqueous detergent composition further comprise a chloride salt. Without being limited by theory, the chloride salt can help prevent and/or reduce the phase changes and separations caused by the builder in the detergent composition. In some embodiments, the chloride salt can comprise potassium chloride, sodium chloride, or combinations thereof. In certain embodiments, the chloride salt can be potassium chloride.

In various embodiments, the chloride salt can be present in the detergent composition in an amount of about 0.1% to about 5% by weight, or about 1% to about 3% by weight, based on the total weight of the aqueous liquid detergent. In certain embodiments, the detergent composition can comprise a chloride salt in an amount of at least about 0.1% by weight, at least about 1% by weight, or at least about 3% by weight, based on the total weight of the aqueous liquid detergent. The water-binding agent and the chloride salt can be present in the detergent composition in a combined total amount of about 25% to about 50% percent by weight, about 30% to about 40% by weight, or about 30% to about 38% by weight, based on the total weight of the aqueous liquid detergent. In certain embodiments, the water-binding agent and the chloride salt can be present in the detergent composition in a combined total amount of about 30% to about 34% by weight, based on the total weight of the aqueous liquid detergent. As further described in the Examples below, while it is most appropriate to discuss the preferable concentrations of salts (i.e., water-binding agents) in terms of molarity or molality, i.e. moles of salt per liter of solution or moles of salt per kilogram of solvent, respectively, it generally can be stated that the concentration ranges for salts are preferably in the range of 5-40% (w/w) considering only the mass of salt and the mass of water in the formula, more preferably in the range of 10-35% (w/w), and most preferably in the range of 15-25% (w/w).

In various embodiments of the invention, the water-binding agent and the chloride salt can be present in the detergent composition in a weight ratio of about 99:1 to about 75:25, or about 98:2 to about 85:15. In certain embodiments, the water-binding agent and the chloride salt can be present in the detergent composition in a weight ratio of about 90:10.

Some embodiments of the aqueous liquid detergent compositions of the present disclosure can further comprise a surfactant. For example, the detergent compositions can comprise a nonionic surfactant, an anionic surfactant, or combinations thereof. In some embodiments, it can be advantageous for a nonionic surfactant to be present in an amount of at least 50% by weight based on the total weight of surfactant employed. As is understood by those skilled in the art, nonionic surfactants lower the critical micelle concentration, and achieve superior oil removal. This ratio of 50% nonionic surfactant to total surfactant present can also act to minimize phase separation within the pouch, as well as to enhance detergency, particularly in hard water. In certain embodiments, the composition can comprise at least one surfactant selected from the group consisting of 12-15 carbon alcohol ethoxylate with 7 moles ethylene oxide per mole of alcohol (e.g., Neodol 25-7 and other similar products available from Shell Global), 12-carbon alkylbenzene sulfonic acid neutralized with monoethanolamine, and sodium laureth sulfate having 2-5 moles ethylene oxide (e.g., Steol® products available from Stepan Company).

As described above, water-soluble films used in various embodiments of the unit dose laundry detergents described herein comprise partially hydrolyzed polyvinyl alcohol acetate (PVOAc) or its derivatives. Without intending to be limited by theory, it is hypothesized that water-soluble films might be further hydrolyzed in high-water content unit dose products, thereby decreasing their water solubility upon use. According to the mechanism of acetate hydrolysis, the two key factors affecting the rate of the film hydrolysis are pH and water activity of the compositions. A pH closer to neutral pH and lower water activity would slow down the hydrolysis.

In various embodiments, the liquid detergent compositions described herein have a pH in the range of about 7 to about 13, or about 7.5 to about 10, or about 8 to about 9.5, or about 8.5 to about 9. In some embodiments, the liquid detergent compositions described herein have a pH of about 13 or less, about 10 or less, about 9.5 or less, about 9 or less, about 8.5 or less, or about 8 or less, but not falling below 7. As noted above, a detergent composition having too high of a pH can lead to undesirable film dissolution. For example, a formula that is too alkaline can cause the film encapsulating the detergent composition to further hydrolyze into forms which are difficult to dissolve in water. As such, unit dose detergent compositions having a high pH can be rendered less suitable for their intended use, particularly after extended periods of storage.

Water activity is the ratio of the water vapor pressure of a product to the vapor pressure of pure water with a range of 0-1. As is known in the art, it describes the “free water” in a composition, which is different from the water content. Water activity can be measured with the Aqualab PAWKIT™ Water Activity Meter, for example. In various embodiments, the liquid detergent compositions described herein can have a water activity value (aw) in the range of about 0.25 to about 0.95, or about 0.35 to about 0.9, or about 0.40 to about 0.85, or about 0.34 to about 0.64, or about 0.40 to about 0.60.

In various embodiments of the present disclosure, the aqueous liquid detergent can be shear-thinning (i.e., as the shear rate increases in a steady shear flow, the viscosity decreases). In certain embodiments, the aqueous liquid detergent can be non-thixotropic. As is known in the art, thixotropy is a time-dependent shear thinning property. Certain gels or fluids that are thick/viscous under static conditions will become thin/less viscous over time when shaken, agitated, sheared, or otherwise stressed (i.e., time dependent viscosity). A thixotropic fluid is a fluid which takes a finite time to attain equilibrium viscosity when introduced to a steep change in shear rate. As such, a thixotropic fluid which demonstrates a decrease in the apparent viscosity under constant shear stress or shear rate, will gradually recover its starting viscosity when the stress or shear rate is removed. By contrast, a non-thixotropic fluid will immediately recover its starting viscosity when the stress or shear rate is removed (i.e., the viscosity effect is not time dependent). See, e.g., An Introduction to Rheology by H. A. Barnes, J. F. Hutton, and K. Walters, 1989, Elsevier Science Rheology Series Volume 3, pages 166 and 168, which is herein incorporated by reference in its entirety. The rheology properties (shear-thinning and non-thixotropic) can be important defining features of embodiments of the aqueous liquid detergent compositions described herein.

In various embodiments, the water-binding agent useful in the detergent compositions described herein can be substantially free of any polar organic compounds. It was surprisingly discovered that the presence of organic compounds (e.g., an organic acetate) in the water-binding agent can cause the film encapsulating the detergent composition to break down/dissolve at a faster rate during storage as compared to compositions that are substantially free of organic compounds. As described in Example 4 below, certain organic compounds and organic salts were tried as water-binding agents in the formulations described herein and found to fail in terms of film integrity.

A method of preparing an aqueous liquid detergent is also provided herein. In various embodiments, the method of preparing the detergent composition can comprise mixing one or more surfactants and a water-binding agent in an aqueous liquid medium to form a detergent composition. In some embodiments, a method of preparing an aqueous liquid detergent comprises first pre-mixing a surfactant such as Steol® with water and then adding any additional surfactants. Optionally, a chloride salt in an aqueous medium can be added to the water/surfactant(s) mixture. As noted above, in certain embodiments, the substantially homogeneous solution forms without the intermediate formation of a gel phase due in part to the incorporation of the chloride salt. It is noted that the purpose/function of the chloride salt described in certain embodiments of the aqueous detergent compositions described herein is separate and different from a water-binding agent as defined in the present disclosure. A water-binding agent (e.g., potassium acetate) in solid form can be added to the mixture. Additional ingredients such as a chelating agent (e.g., EDTA), an antiredeposition polymer (e.g., Acusol), a bittering agent (e.g., Bitrex), and/or an enzyme can be added into the mixture before or after the water-binding agent is added to the water/surfactant(s)/optional chloride salt mixture and mixed. Finally, glycerin can be added to the mixture. The mixture can then be mixed at a high speed of mixing to create a homogeneous solution.

In some embodiments, the method of preparing an aqueous liquid detergent can further include preparing a detergent article by placing a measured amount of the aqueous liquid detergent into a package for the aqueous liquid detergent. As discussed in more detail above, the package can be in direct contact with the aqueous liquid detergent. Furthermore, the package can be formed from a water-soluble, film-forming material, however, the film-forming material is insoluble with respect to the aqueous liquid detergent contained within the package. After placing a measured amount of the aqueous liquid detergent into the package, the water-soluble, film forming material of the package can be heat sealed in order to close the detergent within the package.

### EXPERIMENTAL

### Example 1

Appropriate salt solutions to be used as the water-binding agent in an aqueous detergent composition were identified through a screening test. Solutions with concentrations from 0.1 to 3.0M of various salts were prepared.

Specific salt solutions are identified in Table 1 below. Solutions indicated by white spaces were prepared, while those marked with “X” were not prepared since these exceeded solubility limits of the corresponding salts.

TABLE 1
Solutions used for film stability test

Salt Concentration (M)

| | | | | | | |
|---|---|---|---|---|---|---|
| Salt | 0.1 | 0.5 | 1 | 1.6 | 2.2 | 3 |

| | | | | |
|---|---|---|---|---|
| NaCl | | | | |
| KCl | | | | |
| Na₂CO₃ | | | X | X |
| KCO₃ | | | | |
| MgCl₂ | | | | |
| CaCl₂ | | | | |
| SrCl₂ | | | | X |
| Na-Acetate | | | | |
| K-Acetate | | | | |
| Mg-Acetate | | | | |
| Ca-Acetate | | | X | X |
| Sr-Acetate | | | X | X |
| NaH₂PO₄ | | | | |
| Na₂HPO₄ | X | X | X | X |
| Na₃PO₄ | X | X | X | X |
| KH₂PO₄ | | X | X | X |
| K₂HPO₄ | | | | |
| K₃PO₄ | X | X | X | X |
| Na₂SO₄ | | X | X | X |
| Na₂SO₃ | | | X | X |
| NaHSO₃ | | | | |
| NaNO₃ | | | | |
| NH₄Cl | | | | |
| LiCl | | | | |

About 20 mL of each solution was placed in a glass vial. A strip of PVOH film (Monosol M8630) was cut to dimensions of about 1 cm×6 cm and placed in the vial with the salt solution. The solutions and films were stored at room temperature for about 72 hours. The films were then visually examined for changes in their appearance. The appearance was rated according to the scale provided in Table 2 below.

TABLE 2
Scale for Film Evaluation

| Rating | Appearance |
|---|---|
| 0 | Film fully dissolved |
| 1 | Film mostly dissolved with some residual small pieces |
| 2 | Film not dissolved, but significantly distorted in shape |
| | and swollen |
| 3 | Film not dissolved, shape intact, but plasticized |
| 4 | Film not dissolved, shape intact, with original strength |

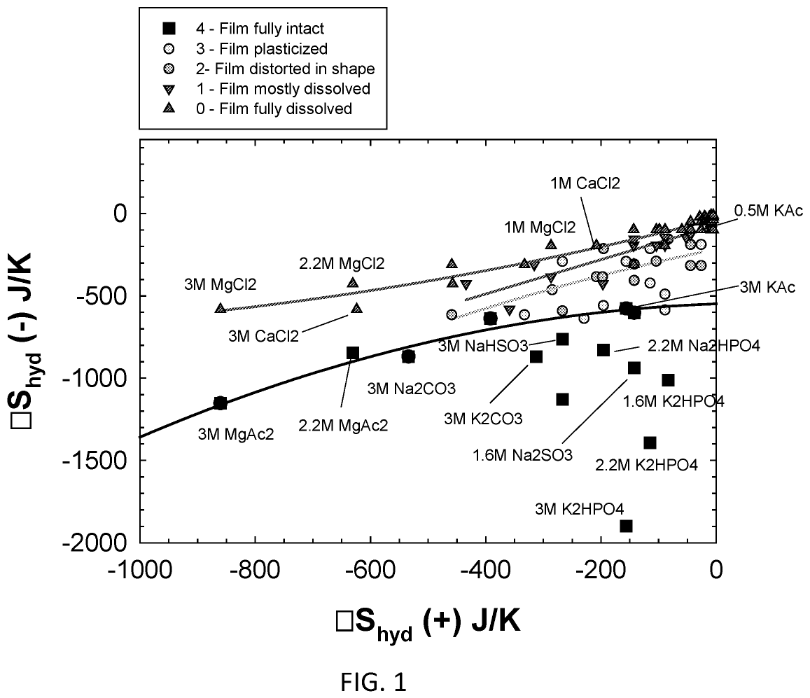

A rating of 4 was the most desirable outcome. Analysis of the data showed that the entropy of hydration (ΔS_{hyd}) of the cation and anion components of the salt was highly relevant to maintaining film stability. FIG. 1 is a plot of the correlation of entropies of hydration between cation and anion. The data were plotted in the space bounded by calculated entropies of hydration for the cation (x-axis) and anion (y-axis) associated with each salt and concentration. The values were calculated by employing molar values from literature known in the art.

It was found that for samples with the film fully intact (i.e., a rating of 4), values shown in FIG. 1 generally fell below the line defined by equation [1] below:

ΔS_{hyd}(−)=−6.890×10⁻⁴[ΔS_{hyd}(+)]2+0.121[ΔS_{hyd}(+)]−548.39 [1]

Therefore, without intending to be limited by theory, it was hypothesized that unit dose systems with salts and concentrations having entropies of hydration for the cation in the range of −1000 to 0 J/K, and having entropies of hydration for the anion for all values less than or equal to ΔS_{hyd}(−) as calculated from equation [1] above to be stable.

FIG. 1 additionally displays the locations of various example salts in the entropy of hydration space. For example, salts considered to be particularly effective in providing film stability and reducing water activity are plotted near or below the line as described by the equation above. Examples include magnesium acetate (MgAc2), potassium carbonate (K₂CO₃), potassium biphosphate (K₂HPO₄), sodium sulfite (Na₂SO₃), and potassium acetate (KAc), as well as others. Non-preferred compounds (which compromise film stability) are shown in the space lying above the line defined by the above equation. These compounds include, for example, magnesium chloride (MgCl₂) and calcium chloride (CaCl₂). FIG. 1 also shows that not only is the type of salt important in determining the film stability, but the concentration as well. It can be seen, for example, that use of 3M KAc produces a stable film, while 0.5M KAc does not. Changing the concentrations of salts like MgAc₂ and K₂HPO₄ changes the corresponding positions in the entropy space.

The film dissolution data and the corresponding entropy of hydration values thus provide a theoretical framework for choosing which salts are most preferable for this invention. While the most preferable salts are defined by the limits of entropies of hydration as described by the equation above, it is generally desired to choose salts having a negative entropy of hydration associated with the cation and an entropy of hydration for the anion on the order of less than −500 J/K.

### Example 2

Using the analysis established in Example 1 above, potential salts that could function as water-binding agents were identified and evaluated.

Four types of new salts (i.e., to be used in place of potassium carbonate) were identified as promising water-binding agents to enhance the film dissolution property of high-water content unit dose laundry detergents: (1) sodium citrate (NaCitrate), (2) potassium citrate (KCitrate), (3) sodium acetate (NaAc), and (4) potassium acetate (KAc). A model study was run with study compositions comprising 61.00 weight percent deionized water, 5.00 weight percent glycerin, and 34.00 weight percent of salts. For each of the four salt candidates, the combinations provided in Table 3 below were tested, which included partially or completely replacing potassium carbonate (K₂CO₃), a water-binding agent that has been used in other commercially available detergent compositions. Each of the combinations was used as the 34.00 weight percent of salts in the model study composition.

TABLE 3
Different Combinations of Each New Salt
Salts Description
K₂CO₃:New Salt = 100:0
K₂CO₃:New Salt = 75:25
K₂CO₃:New Salt = 50:50
K₂CO₃:New Salt = 25:75
K₂CO₃:New Salt = 0:100
K₂CO₃:Na₂SO₄:New Salt = 15:10:75
K₂CO₃:Na₂SO₄:New Salt = 5:20:75
Na₂SO₄:New Salt = 25:75

In order to mimic the unit dose system, actual pods were prepared for each of the model study solutions. Monosol™ M8312 film with shiny side in was chosen to make the pods. 20 grams of solution was added to freshly made pods. The pods were then put into plastic bottles and stored at room temperature and 50° C. conditions. Following the standard operation procedure (TM-FC-039), film dissolution testing was conducted in 10° C. cold water at assigned time points. The study results showed that films with the following salts and/or their combinations dissolved faster than films with a detergent only including potassium carbonate in the 34.00% salts portion of the study compositions.
1) K₂CO₃:NaCitrate=75:25
2) NaCitrate 100%
3) Na₂SO₄:NaCitrate=25:75
4) Potassium Citrate 100%
5) Potassium Acetate 100%

Next, the pH and water activity of the model study compositions for each of the 5 identified salt combinations above. The results are provided in Table 4 below.

TABLE 4
pH and a_{w} of Model Study Formulation
having Different Salt Combinations

| Salts Used in Formulation | pH | a_{w} |
|---|---|---|
| K₂CO₃ 100% | 12.87 | 0.75 |
| K₂CO₃:NaCitrate = 75:25 | 12.64 | 0.79 |
| NaCitrate 100% | 8.11 | 0.86 |
| Na₂SO₄:NaCitrate = 25:75 | 7.98 | 0.85 |
| Potassium Citrate 100% | 8.86 | 0.86 |
| Potassium Acetate 100% | 8.68 | 0.74 |

It was found that formulas with potassium carbonate (K₂CO₃) had very high pH (12.87) and relatively low water activity (0.75); however, formulas with potassium acetate (KAc) had much lower pH (8.68) and similar water activity (0.74). Without intending to be limited by theory, this means KAc might be able to bind water in a similar degree as K₂CO₃, but it could provide the formula with much lower pH, which might be able to slow down the film hydrolysis and thus lead to better film dissolution property of high-water content unit dose laundry detergents. The corresponding film dissolution testing results were consistent with this hypothesis.

The endpoint of film dissolution testing was set as 20 mins. As shown in Table 5A and Table 5B below, films with potassium acetate dissolved faster than films with only potassium carbonate in the model study formulas at both room temperature and 50° C. storage conditions.

TABLE 5A
Film Dissolution Results of Direct Comparison

| | | | Film | | | Film | |
|---|---|---|---|---|---|---|---|
| | | Time | Breaks | Dissolution | Time | Breaks | Dissolution |
| Product | Temp | (days) | (mins) | (mins) | (days) | (mins) | (mins) |
| 100% K₂CO₃ | RT | 1 | 1:24 | 15:29 | 7 | 1:14 | >20.00 |
| | | | 1:13 | 14:11 | | 1:24 | >20.00 |
| 75:25 K₂CO₃: | RT | 1 | 1:36 | 10:38 | 7 | 1:32 | >20.00 |
| NaCitrate | | | 1:17 | 5:21 | | 1:29 | >20.00 |
| 100% | RT | 1 | 1:16 | 3:34 | 7 | 1:37 | 9:46 |
| NaCitrate | | | 1:14 | 5:12 | | 1:33 | 6:00 |
| 25:75 Na₂SO₄: | RT | 1 | 1:13 | 5:24 | 7 | 1:29 | 5:24 |
| NaCitrate | | | 1:21 | 5:56 | | 1:28 | 3:43 |
| 100% | RT | 1 | 1:09 | 6:50 | 7 | 1:17 | 2:42 |
| Potassium | | | 1:00 | 5:46 | | 1:11 | 4:14 |
| Acetate | | | | | | | |
| 100% | RT | 1 | 1:15 | 7:22 | 7 | 1:34 | 4:20 |
| Potassium | | | 1:13 | 5:07 | | 1:26 | 3:41 |
| Citrate | | | | | | | |
| 100% K₂CO₃ | 50° C. | 1 | 1:50 | >20.00 | 7 | 6:45 | >20.00 |
| | | | 2:27 | >20.00 | | 3:26 | >20.00 |
| 75:25 K₂CO₃: | 50° C. | 1 | 4:51 | >20.00 | 7 | 3:50 | >20.00 |
| NaCitrate | | | 3:08 | >20.00 | | 4:41 | >20.00 |
| 100% | 50° C. | 1 | 3:47 | 14:42 | 7 | 6:02 | >20.00 |
| NaCitrate | | | 4:02 | 17:52 | | 6:39 | >20.00 |
| 25:75 Na₂SO₄: | 50° C. | 1 | 2:55 | >20.00 | 7 | 5:36 | >20.00 |
| NaCitrate | | | 4:05 | >20.00 | | 4:47 | >20.00 |
| 100% | 50° C. | 1 | 3:18 | >20.00 | 7 | 10:14 | >20.00 |
| Potassium | | | 4:25 | >20.00 | | 5:28 | 18:58 |
| Acetate | | | | | | | |
| 100% | 50° C. | 1 | 3:47 | >20.00 | 7 | 5:30 | >20.00 |
| Potassium | | | 4:12 | >20.00 | | 7:54 | >20.00 |
| Citrate | | | | | | | |

TABLE 5B
Film Dissolution Results of Direct Comparison

| | | | Film | | | Film | |
|---|---|---|---|---|---|---|---|
| | | Time | Breaks | Dissolution | Time | Breaks | Dissolution |
| Product | Temp | (days) | (mins) | (mins) | (days) | (mins) | (mins) |
| 100% K₂CO₃ | RT | 14 | 1:23 | >20.00 | 21 | 2:26 | >20.00 |
| | | | 1:34 | >20.00 | | 2:03 | >20.00 |
| 75:25 K₂CO₃: | RT | 14 | 1:57 | >20.00 | 21 | 2:38 | >20.00 |
| NaCitrate | | | 1:40 | >20.00 | | 2:11 | >20.00 |
| 100% | RT | 14 | 1:29 | 6:26 | 21 | 1:44 | 14:00 |
| NaCitrate | | | 1:45 | 9:28 | | 1:55 | 9:01 |
| 25:75 Na₂SO₄: | RT | 14 | 1:30 | 11:33 | 21 | 1:29 | 4:41 |
| NaCitrate | | | 1:34 | 4:55 | | 1:47 | 6:30 |
| 100% | RT | 14 | 1:22 | 6:17 | 21 | 1:15 | 3:04 |
| Potassium | | | 1:20 | 6:46 | | 1:20 | 4:23 |
| Acetate | | | | | | | |
| 100% | RT | 14 | 1:38 | 8:26 | 21 | 1:50 | 13:25 |
| Potassium | | | 1:32 | 7:43 | | 1:48 | 12:16 |
| Citrate | | | | | | | |
| 100% K₂CO₃ | 50° C. | 14 | 3:29 | >20.00 | 21 | 4:26 | >20.00 |
| | | | 3:17 | >20.00 | | 2:58 | >20.00 |
| 75:25 K₂CO₃: | 50° C. | 14 | 4:43 | >20.00 | 21 | 3:55 | >20.00 |
| NaCitrate | | | 3:19 | >20.00 | | 3:53 | >20.00 |
| 100% | 50° C. | 14 | 11:07 | >20.00 | 21 | 17:45 | >20.00 |
| NaCitrate | | | 13:18 | >20.00 | | 17:02 | >20.00 |
| 25:75 Na₂SO₄: | 50° C. | 14 | 7:25 | >20.00 | 21 | 6:29 | >20.00 |
| NaCitrate | | | 6:08 | >20.00 | | 7:15 | >20.00 |
| 100% | 50° C. | 14 | 11:45 | >20.00 | 21 | 9:18 | >20.00 |
| Potassium | | | 10:38 | >20.00 | | 10:28 | >20.00 |
| Acetate | | | | | | | |
| 100% | 50° C. | 14 | 8:13 | >20.00 | 21 | 10:43 | >20.00 |
| Potassium | | | 11:13 | >20.00 | | 17:11 | >20.00 |
| Citrate | | | | | | | |

The selection of preferred water-binding agents for use in the compositions described herein was made by evaluating pH, water activity and film dissolution effects. For example, sodium citrate failed because the formula with it had relatively higher water activity, and the films were less stable than films with the formula including potassium acetate.

### Example 3

The potassium acetate effect on film dissolution of high-water content unit dose system was tested with a slurry type of high-water content unit dose formula. A comparison potassium carbonate detergent composition (the control) was made according to Table 6 below.

TABLE 6
Unit Dose of Laundry Detergent Formulation Comprising
Potassium Carbonate and Potassium Chloride

| Ingredient | Weight % |
|---|---|
| Water | 16.979 |
| Glycerine | 5 |
| Sodium Laureth Sulfate, 70% | 28.217 |
| Potassium Chloride | 1 |
| Monoethanolamine (MEA) | 0.41 |
| Brightener CBS SP 33% | 0.68 |
| R&H Polymer 445 (49%) | 1.24 |
| Linear Alkylbenzene Sulfonic Acid | 1.418 |
| Ethoxylated Alcohols | 12.056 |
| Potassium Carbonate | 32.00 |
| Water | 1.00 |
| Totals | 100 |

The previous 32% K₂CO₃ was used as the control and various levels (28%-40%) of KAc were tested. It was found that 1:1 replacement of 32% K₂CO₃ with 32% KAc provided the formula with much lower pH (12.62 vs 8.22) and similar water activity. Table 7 below shows the pH and water activity for different levels of potassium acetate. For formulas comprising potassium acetate in an amount of less than 32%, the amount of glycerin was increased to reach 100% for the total ingredients. For formulas comprising potassium acetate in an amount of more than 32%, the amount of water was reduced such that the total weight percentage of ingredients is 100%.

TABLE 7
pH and a_{w} of Detergent Formulations with
Different Levels of Potassium Acetate

| Salts Used in Formulation | pH | a_{w} |
|---|---|---|
| K₂CO₃ 100% | 12.62 | 0.58 |
| KAc 28% | 8.20 | 0.59 |
| KAc 32% | 8.22 | 0.55 |
| KAc 34% | 8.37 | 0.34 |
| KAc 36% | 8.62 | 0.46 |
| KAc 38% | 8.29 | 0.45 |
| KAc 40% | 8.93 | 0.42 |

The corresponding film dissolution testing results showed that all films with slurry type of high-water content compositions stored at room temperature dissolved within 20 mins in cold water (10° C.). For films stored at 50° C., the film dissolution results clearly showed that all films with compositions comprising 28-40% KAc dissolved faster than films with compositions comprising 32% K₂CO₃ in cold water.

The potassium acetate (KAc) range was then extended to 16% and 48%. As illustrated in Table 8 below, the pH and water activity of these compositions showed a similar trend as the trend illustrated in Table 7 above.

TABLE 8
pH and a_{w} of Detergent Formulations with
Different Levels of Potassium Acetate

| Salts Used in Formulation | pH | a_{w} |
|---|---|---|
| K₂CO₃ 100% | 12.40 | 0.56 |
| KAc 16% | 7.17 | 0.64 |
| KAc 24% | 7.87 | 0.62 |
| KAc 32% | 7.82 | 0.57 |
| KAc 42% | 8.80 | 0.38 |
| KAc 44% | 9.06 | 0.31 |
| KAc 48% | 9.35 | 0.25 |

Formulas with a lower amount of KAc had lower pH but relatively higher water activity, and formulas with a higher amount of KAc had slightly higher pH, but lower water activity. For films stored at room temperature, the film dissolution results clearly showed that all films with compositions comprising 16-48% KAc dissolved within 20 minutes. For films stored at 50° C., films with a composition comprising a smaller amount of KAc (e.g., less than 28%) dissolved slow. Films with compositions comprising at least 32% KAc provided good film dissolution properties.

Formula appearance was also evaluated during the KAc level testing. Although most of the formulas with the various levels of KAc were phase separated, formulas with 16%, 34%, and 36% of potassium acetate (KAc) showed high uniformity even after 5 months at room temperature.

In summary, potassium acetate (KAc) was found to be a suitable water-binding agent in high-water content unit does laundry detergents for good film dissolution property. In a slurry-type high-water content unit does composition, 32% or more of potassium acetate provided much faster film dissolution properties than slurry-type high-water content unit does compositions comprising 32% potassium carbonate. Additionally, the compositions with 34-36% potassium acetate showed promising formula storage stability (i.e., detergent compositions within the film pods did not separate, yellow, or demonstrate slow film dissolution in cold water use after extended storage periods).

Table 9 below demonstrates an example aqueous detergent composition according to the present disclosure.

TABLE 9
Aqueous Detergent Composition According
to an Embodiment of Present Disclosure

| Ingredient | Wt. % |
|---|---|
| Water- tap water | 33.9250 |
| Glycerine | 5.0000 |
| Sodium Laureth Sulfate, 70% | 9.2710 |
| Potassium Chloride | 1.0000 |
| Monoethanolamine (MEA) | 0.4100 |
| Brightener CBS SP 33% | 0.6800 |
| R&H Polymer 445 (49%) | 1.2400 |
| Linear Alkylbenzene Sulfonic Acid | 1.4180 |
| Ethoxylated Alcohols | 12.0560 |
| Potassium Acetate | 34.0000 |
| Water- tap water | 1.0000 |
| Totals | 100.0000 |

Table 10 below demonstrates an example aqueous detergent composition according to the present disclosure.

TABLE 10
Aqueous Detergent Composition According
to an Embodiment of Present Disclosure

| Ingredient | Wt. (g) |
|---|---|
| Water- tap water | 1-60 |
| Glycerine | 5-10 |
| Sodium Laureth Sulfate, 70% | 10-15 |
| Versene | 0.1-1.0 |
| Acusol 445N | 0.5-2.0 |
| Glucopn 420UP (50% actives) | 15-25 |
| Polyethylene glycol 8000 | 0-15 |
| Polyethylene glycol 400 | 0-15 |
| Water-binding agent (e.g. Mg-acetate-4H20) | 10-55 |
| Total Weight % Water | 34-76% |

### Example 4

A control study was conducted by comparing inorganic electrolytes, such as potassium carbonate and potassium acetate, and organic electrolytes, such as mono ethanol amine citrate, in the slurry formula described in Table 11 below. Potassium carbonate and mono ethanol amine citrate are water binding agents used in commercially available aqueous liquid detergent compositions. Potassium acetate is the binding agent used in an aqueous liquid detergent composition prepared according to the present disclosure.

TABLE 11
Slurry Type of High-Water Content Unit Dose Composition

| Ingredient | Wt % |
|---|---|
| Water- tap water | 35.925 |
| Glycerine | 5.000 |
| Steol 25-3S/70FC -23% solution | 9.271 |
| Potassium Chloride | 1.000 |
| Monoethanolamine (MEA) | 0.410 |
| Brightener CBS SP 33% | 0.680 |
| R&H Polymer 445 (49%) | 1.240 |
| Biosoft S-118 | 1.418 |
| Neodol 25-7 | 12.056 |
| Water binding agent | 32.000 |
| Water- tap water | 1.000 |
| Totals | 100.000 |

The pH and water activity data of these compositions is provided in Table 12 below. Compositions with potassium acetate or mono ethanol amine citrate had a much lower pH than the composition with potassium carbonate (8.28 or 7.01 vs 12.24). As for water activity, the composition with potassium acetate had lower water activity than the composition with potassium carbonate (0.5867 vs 0.6046), however, the composition with mono ethanol amine citrate had higher water activity than the composition with potassium carbonate (0.8037 vs 0.6046).

TABLE 12
pH and a_{w} of Control Study

| Water Binding Agent | pH | a_{w} |
|---|---|---|
| Potassium Carbonate | 12.24 | 0.6046 |
| Potassium Acetate | 8.28 | 0.5867 |
| Mono Ethanol Amine Citrate | 7.01 | 0.8037 |

Based on the above data, it is apparent that inorganic and organic electrolytes have different pH effects on the compositions and different water binding capabilities. Water activity of the composition with mono ethanol amine citrate, the preferred water binding agent in certain commercially available detergent compositions (see, e.g., the compositions described in DE60204914T2), fell out of the water activity range of the preferred slurry type of high-water content unit dose composition comprising potassium carbonate (0.8037 vs 0.34-0.46). See, e.g., the detergent compositions comprising potassium carbonate described in U.S. Pat. Pub. No. 2006/0281658, which is herein incorporated by reference in its entirety.

Furthermore, the different pH and water binding capabilities of inorganic and organic electrolytes have different effects on the stability of the water-soluble films of high-water content unit dose products. As described above, a pH of the detergent composition that is closer to neutral pH and a detergent composition having a lower water activity would slow down the hydrolysis of the polyvinyl alcohol acetate (or its derivatives) film encapsulating the detergent composition. Accordingly, the pH and water activity of the composition with potassium acetate according to the present disclosure causes a greater decrease in the rate of film hydrolysis than the composition with potassium carbonate. The composition with mono ethanol amine citrate had a pH that would decrease the rate of film hydrolysis as compared to the composition with potassium acetate, but the water activity would increase the rate of film hydrolysis. Film dissolution data for the different compositions is provided in Table 13A and Table 13B below.

TABLE 13A
Film Dissolution Data

| | | | Dissolution | | Dissolution |
|---|---|---|---|---|---|
| Builder | Temp. | Time | (min) | Time | (min) |
| K₂CO₃ | RT | 0 | 8:09 | 1 wk | 8:33 |
| | | | 4:26 | | 11:54 |
| KAc | RT | 0 | 6:02 | 1 wk | 12:30 |
| | | | 7:44 | | 3:02 |
| MEA:Citric | RT | 0 | 3:45 | 1 wk | 6:05 |
| Acid | | | 7:55 | | 4:05 |
| K₂CO₃ | 50 C. | 0 | 9:00 | 1 wk | >20:00 |
| | | | 12:42 | | >20:00 |
| KAc | 50 C. | 0 | 5:33 | 1 wk | 8:16 |
| | | | 6:32 | | 9:04 |
| MEA:Citric | 50 C. | 0 | 5:52 | 1 wk | 7:56 |
| Acid | | | 8:23 | | >20:00 |

TABLE 13B
Film Dissolution Data

| | | | Dissolution | | Dissolution |
|---|---|---|---|---|---|
| Builder | Temp. | Time | (min) | Time | (min) |
| K₂CO₃ | RT | 2 wk | 10:51 | 3 wk | 14:55 |
| | | | 13:00 | | 14:03 |
| KAc | RT | 2 wk | 4:54 | 3 wk | 6:46 |
| | | | 4:19 | | 6:20 |
| MEA:Citric | RT | 2 wk | 3:00 | 3 wk | 8:49 |
| Acid | | | 4:01 | | 8:37 |
| K₂CO₃ | 50 C. | 2 wk | >20:00 | 3 wk | >20:00 |
| | | | >20:00 | | >20:00 |
| KAc | 50 C. | 2 wk | 9:24 | 3 wk | 9:42 |
| | | | 6:07 | | 9:55 |
| MEA:Citric | 50 C. | 2 wk | >20:00 | 3 wk | >20:00 |
| Acid | | | | | |

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An article comprising:
an aqueous liquid detergent comprising:
at least about 25% by weight of water based on the total weight of the aqueous liquid detergent; and
at least about 25% by weight of a water-binding agent based on the total weight of the aqueous liquid detergent;
wherein the aqueous liquid detergent has a pH in the range of about 7 to about 10, and wherein the aqueous liquid detergent has a water activity in the range of about 0.30 to about 0.64; and
a package for the aqueous liquid detergent which is in direct contact with the aqueous liquid detergent, wherein the package is formed from a water-soluble, film-forming material.

2. The article of claim 1, wherein the water-binding agent comprises at least one inorganic salt.

3. The article of claim 1, wherein the water-binding agent is potassium acetate.

4. The article of claim 1, wherein the water-binding agent is present in an amount in the range of about 30 to about 40 weight percent based on the total weight of the aqueous liquid detergent.

5. The article of claim 1, further comprising at least one surfactant.

6. The article of claim 1, wherein the water-soluble film-forming material is polyvinyl alcohol.

7. The article of claim 1, further comprising a chloride salt.

8. The article of claim 7, wherein the chloride salt is potassium chloride.

9. The article of any one of claims 1-8, wherein the aqueous liquid detergent has a pH in the range of about 7.5 to about 9.

10. The article of any one of claims 1-8, wherein the water activity of the aqueous liquid detergent is in the range of about 0.40 to about 0.60.

11. The article of any one of claims 1-8, wherein the water is present in an amount of about 20 to about 45 weight percent, based on the total weight of the aqueous liquid detergent.

12. The article of any one of claims 1-8, wherein the water-binding agent is substantially free of organic compounds.

13. The article of any one of claims 1-8, wherein the water-binding agent has a negative entropy of hydration associated with the cation and an entropy of hydration for the anion on the order of less than about −500 J/K.

14. The article of any one of claims 1-8, wherein the concentration of the water-binding agent in the aqueous liquid detergent composition is in the range of about 5 to about 40% (w/w/).

15. An aqueous liquid detergent comprising:
at least about 25% by weight of water based on the total weight of the aqueous liquid detergent; and
at least about 25% by weight of a water-binding agent based on the total weight of the aqueous liquid detergent;
wherein the pH of the aqueous liquid detergent is in the range of about 7 to about 10, and wherein the water activity of the aqueous liquid detergent is in the range of about 0.34 to about 0.64.

16. The aqueous liquid detergent of claim 15, wherein the water-binding agent comprises at least one inorganic salt.

17. The aqueous liquid detergent of claim 15, wherein the water-binding agent is potassium acetate.

18. The aqueous liquid detergent of claim 15, wherein the water-binding agent is present in an amount in the range of about 30 to about 40 weight percent based on the total weight of the aqueous liquid detergent.

19. The aqueous liquid detergent of claim 15, further comprising at least one surfactant.

20. The aqueous liquid detergent of claim 15, further comprising a chloride salt.

21. The aqueous liquid detergent of claim 20, wherein the chloride salt is potassium chloride.

22. The aqueous liquid detergent of any one of claims 15-21, wherein the aqueous liquid detergent has a pH in the range of about 7.5 to about 9.

23. The aqueous liquid detergent of any one of claims 15-21, wherein the water activity of the aqueous liquid detergent is in the range of about 0.40 to about 0.60.

24. The aqueous liquid detergent of any one of claims 15-21, wherein the water is present in an amount of about 20 to about 45 weight percent, based on the total weight of the aqueous liquid detergent.

25. The aqueous liquid detergent of any one of claims 15-21, wherein the water-binding agent is substantially free of organic compounds.

26. The aqueous liquid detergent of any one of claims 15-21, wherein the water-binding agent has a negative entropy of hydration associated with the cation and an entropy of hydration for the anion on the order of less than about −500 J/K.

27. The aqueous liquid detergent of any one of claims 15-21, wherein the concentration of the water-binding agent in the aqueous liquid detergent composition is in the range of about 5 to about 40% (w/w/).
